(19) United States
(12) Patent Application Publication
(10) Pub. No.: US 2021/0062803 A1
(43) Pub. Date: Mar. 4, 2021

(54) METHOD AND SYSTEM FOR MONITORING THE CONDITION OF ROTATING SYSTEMS

(71) Applicants: MAGNETIC PUMPING SOLUTIONS LLC, Houston, TX (US); MAGNETIC PUMPING SOLUTIONS LIMITED, Oxfordshire (GB)

(72) Inventors: Michael Yuratich, Hamble (GB); Georgios Orfanoudakis, Heraklion (GR)

(21) Appl. No.: 16/964,867

(22) PCT Filed: Jan. 24, 2019
(86) PCT No.: PCT/US19/14874

§ 371 Date: Jul. 24, 2020

Related U.S. Application Data
(60) Provisional application No. 62/621,068, filed on Jan. 24, 2018.

(51) Int. Cl. F04B 49/06; F04B 17/03; F04B 49/20; F04B 47/00

(52) U.S. Cl. CPC F04B 49/065; F04B 17/03; F04B 49/20; F04B 2203/0207; F04B 2203/0201; F04B 2203/0202; F04B 2203/0209; F04B 47/00

(57) ABSTRACT

An apparatus and method is disclosed to monitor the operating condition of a rotational electromechanical system and to further sense and diagnose an abnormal condition of such systems in real time. The apparatus and method includes an improved technique of monitoring such systems, detecting problems, diagnosing causes and acting on the problems to reduce failures and increase production.

### Cross Reference to Related Applications

This application claims the benefit of U.S. Provisional Patent Application Ser. No. 62/621,068 filed 24 Jan. 2018 as well as Patent Cooperation Treaty Patent Application Serial No PCT/US2019/14874 filed 24 Jan. 2019. The disclosure of the applications above are incorporated herein by reference in their entirety.

### BACKGROUND OF THE INVENTION

### Field of the Invention

The present disclosure relates generally to monitoring the condition of rotating equipment and more specifically to downhole pumping systems, and particularly in reference to permanent magnet motor-driven pumping systems.

### Description of the Related Art

There exist many rotary driven devices in industry. Many of these rotary driven devices are powered by electric motors in critical applications for long durations and the ability to monitor the condition of the rotating components of these electromechanical systems is known to be desirable. Many such monitoring systems exist which include sensors to measure vibration, noise, torque and the like. Electromechanical systems included in downhole pumping systems provide additional challenges in that the systems may be positioned thousands of feet below the surface in extremely harsh environmental conditions and with very limited data communications capability.

Downhole pumping systems are a widely used method of artificial lift, whereby a pump coupled to an electric motor are deployed in a borehole are used to bring liquid and gas to surface. Artificial lift is necessary when the natural well pressure is insufficient to do so by itself. The motor is powered via a length of electric cable rising to surface and thence connected to control equipment.

Referring to FIG. 1, there is shown a typical downhole pumping system installed in a wellbore. As is known, a borehole drilled in an earth formation 1 may be lined with casing 2 cemented to the surrounding formation. A motor 10 is coupled to a pump 12 via a motor seal 11. The pump discharge end 13 is attached to production tubing 3. Production fluid (not shown) enters the well via perforations 4 in the casing 2 and enters the pump at its intake 14. The production tubing 3 runs up the borehole through the wellhead 6 and on to surface production facilities. In a typical installation, motor 10 comprises a three-phase motor and is powered via a three-conductor electric cable 15, which runs up to surface alongside and clamped to the production tubing 3 in a manner well known in the art. The cable 15 then penetrates through the wellhead 6 and runs to a vented junction box 20. In the embodiment shown, surface electric power source 21 is converted by drive unit 22 to a frequency and, via step-up transformer 23 to a scaled voltage needed by the motor 10, allowing for voltage drop in the cable. The output of the transformer 23 is connected in the vented junction box 20 to the motor cable 15. In other embodiments, older installations for example, drive unit 22 may simply comprise a switch-board that passes the supply voltage directly to the transformer via a controllable contactor and protective fuses. In the current area of art, drive unit 22 is preferably a variable speed drive as this permits optimization of production and energy savings. A variable speed drive is in any case required for permanent magnet motors (PMMs) due to the need for synchronous control. A control unit 24, whether separate or incorporated within the drive unit 22, may be used to stop and start the motor and potentially to reverse the motor direction by switching phase connections as is known.

There exists several methods of controlling downhole pumping systems in the prior art. One such method is scalar control, which only adjusts the magnitude and frequency of the voltages applied to the motor. Scalar control variants typically do not require knowledge of the motor's shaft angular position and speed. For synchronous motors, in particular, these methods assume that the motor is running at the synchronous speed which is determined by the drive output frequency. Yet another method of controlling AC motors (and downhole pumping systems thereby) is vector control. As opposed to scalar control, vector control methods require knowledge of the shaft angular position and speed, which for downhole motors is typically provided by an observer or estimator. These methods adjust the drive pulse-width modulated output voltage on a pulse-by-pulse basis taking into account the observed shaft angle, thus more accurately controlling all characteristics of the motor voltage and current waveforms, and hence its speed and torque.

[0007]The predominant prior art method for controlling downhole AC motors using variable speed drives is scalar control, which only adjusts the magnitude and frequency of the voltages applied to the motor. Scalar control variants typically do not require knowledge of the motor's shaft angular position and speed. For synchronous motors, and permanent magnet motors (PMMs) in particular, these methods assume that the motor is running at the synchronous speed which is determined by the drive output frequency, and are unreliable in that they easily lose control. Another method of controlling AC motors (and downhole pumping systems thereby) is vector control. As opposed to scalar control, most vector control methods require knowledge of the shaft angular position and speed, which for downhole motors is typically provided by an observer, also known as an estimator. An observer typically comprises an electrical model of the motor, surface measurements of voltage and current and a phase-locked loop (PLL). A PLL can be digitally-implemented in the form of an algorithm, providing an estimate of the phase and frequency of a periodic input signal such as the drive output voltage or current. Control methods using such observers are known as sensorless in that they do not require physical shaft rotation sensors. They are particularly useful for downhole applications, where the motors are positioned remotely from the drives that control them. These methods adjust the drive output voltage on a pulse-by-pulse basis, thus more accurately controlling all characteristics of the motor voltage and current waveforms, and hence its speed and torque. Not all vector controls employ observers directly, but sensorless vector drives share the use of a motor model and surface electrical measurements to accurately control the torque-producing component of the motor current. For a PMM this is sensibly the actual motor current whereas for induction motors the motor current also contains a magnetizing current component. In general, vector controls are fast and accurate controllers that tightly regulate the torque-producing motor current, herein referred to as “stiff” current control (and sometimes referred to as hard current control), with or without an observer, and may be applied to both induction motors and permanent magnet motors. In such cases, vector controllers use pre-defined values of requested speed or torque, which can be fixed or ramped towards a given direction. The angle of the shaft is calculated as the integral of the observed (actual) instantaneous speed. In such systems the instantaneous voltage and current supplied to the motor are input to the observer which using motor parameters such as inductance and resistance can then estimate the three phase electromotive force (EMF) of the motor, whose phase and frequency is directly that of the instantaneous rotor electrical position and frequency and is determined and output by the observer.

Centrifugal pumps (ESPs) of the prior art are commonly used in downhole pumping systems as well as progressive cavity pumps (PCPs), each driven by an attached motor. Historically, ESP as a category of artificial lift, referred exclusively to induction motor driven centrifugal pumps. Newer downhole pumping systems employ a permanent magnet motor (PMM) to drive the pump.

ESPs, or centrifugal pumps, are from the family of hydrodynamic pumps including such known types as radial flow, mixed flow, axial flow and helico-axial flow which generally operate at speeds of thousands of revolutions per minute and obey the known affinity laws which relate shaft speed to torque and fluid head. They are made in multiple stages, often more than one hundred, and have a relatively open path to fluid throughout their length.

PCPs of the prior art are a type of positive-displacement pump, operating in the low hundreds of revolutions per minute. A steel rotor is almost always in rubbing contact with an elastomer stator such that a series of essentially sealed cavities are formed along the length of the rotor—stator interface. The rubbing contact is associated with relatively low leakage and with rubbing friction. The friction at the moment of starting is static friction and can be several times higher than the dynamic friction when running normally. The shaft torque needed to overcome static friction is commonly referred to as breakout torque.

In addition to normal operating friction and torque requirements, it is known in the art that the rotating components of a downhole pumping system are subject to complications, including degradation and failure, that adversely affect production. Such problems also include wear, debris, gas slugging, scale, sand, corrosion and mechanical failure, among others. Some of these complications may be intermittent, regularly occurring or one-time occurrences. Many downhole pumping systems use various sensors and methods to monitor for these complications and report information related thereto to the surface.

Downhole pumping systems of the prior art use various methods for communicating operating information related to the downhole components to drive unit 22 at the surface. For instance, physical parameters of the system such as pressure, temperature and other operating parameters may be transmitted by downhole gauge 30 through motor 10 and up cable 15. Such communications systems may include SCADA reporting systems that operate on the order of minutes or data logging systems that operate on the order of several seconds. As described hereinabove, because the rotating components may be operating at high speed, such communications systems may not have the ability to capture rapid changes in such physical parameters suggestive of significant events in order for an operator to have advanced warning of a problem. Without proper warning an operator is not able to alter the operation of the downhole pumping system in a manner that could avoid or postpone a failure.

One method to monitor the operational condition of rotating components of an electromechanical system is set forth in U.S. Pat. No. 9,459,088 (the '088 patent). The method taught in the '088 patent involves measuring current and/or voltage signals and measuring the angular position of rotating shaft of an induction motor driven compressor system. The measured current and/or voltage signals are synchronized to scaled angular displacement of shaft. The synchronous electrical signals are divided into intervals according to a completed rotation of the shaft. The characteristic data of magnitude of the electrical signals is extracted from average synchronous electrical signal values. In other words, the data from an interval of rotation for a particular rotation of the shaft is compared to the same interval for successive rotations. The extracted characteristic data of magnitude of the electrical signals is compared with a predetermined threshold which is given as a limit and alarm is indicated to a user when the limit is exceeded. When the magnitude of the measured current and/or voltage for an interval as compared to successive rotations for the same interval exceeds the predetermined threshold, it may be indicative of a fault or failure of a rotating component of the electromechanical system. The method of the '088 patent lacks the ability to diagnose the cause of the abnormal condition and further is not applicable to vector control of electromechanical systems wherein the stator currents are controlled by the drive to maintain the motor at a predetermined speed. In addition, the method of the '088 lacks the ability to determine abnormal operating conditions that are synchronous within the particular angular interval. For instance, if there was a static rubbing condition present within an angular interval on every rotation the change in the current or voltage signals for that particular interval would not change and would not exceed the threshold limit that would trigger an alarm.

Another prior art method to detect a rotation restriction of rotating components of an electromechanical system is set forth in U.S. Pat. No. 9,698,714 (the '714 patent). The method taught in the '714 is related to variable speed drives for controlling PMMs coupled to ESPs. The method includes the ability to sense a rotational restriction of the pump, restricted by sand for example, by detecting an asynchronous condition of the motor. When an asynchronous condition is detected, the method of the '714 patent stops the motor and then drives the motor in prescribed asynchronous condition to free the rotation restriction by what is described as a “jackhammer-like” cycle. While the method of the 714 patent is able to detect the existence of an abnormal rotational condition of a PMM driven electromechanical system, it does nothing to maintain synchronous control of the PMM.

For at least the reasons stated herein before, it is desirable to be able to monitor the operating condition of a rotational electromechanical system and to further sense and diagnose an abnormal condition of such systems in real time. There is clearly a need for an improved means of monitoring such systems, detecting problems, diagnosing causes and acting on the problems to reduce failure and increase production.

### SUMMARY OF THE INVENTION

One general aspect includes an apparatus for monitoring the condition of an electromechanical system. The apparatus also includes means for determining at least one parameter of the electromechanical system. The apparatus also includes a computing device configured to perform particular operations or actions by virtue of having software, firmware, hardware, or a combination of them and capable of monitoring the at least one parameter and comparing the at least one parameter to a predetermined set of limits of the at least one parameter. The apparatus also includes the computing device capable of determining a condition of the electromechanical system. Other embodiments of this aspect include corresponding computer systems, apparatus, and computer programs recorded on one or more computer storage devices, each configured to perform the actions of the methods.

Implementations may include one or more of the following features. The apparatus where the computing device is capable of correlating the at least one parameter over a predetermined time interval to produce a correlated data set. The apparatus where a stable condition is determined if the at least one parameter is within the predetermined set of limits and where an abnormal condition is determined if the at least one parameter is outside of the predetermined set of limits. Implementations of the described techniques may include hardware, a method or process, or computer software on a computer-accessible medium.

One general aspect includes an apparatus for monitoring a downhole pumping system including a motor having a shaft, a pump couple to the shaft of the motor, a drive electrically capable of being coupled to a power source and to the motor, the drive including a computing device, an observer and non-volatile memory, where the drive is capable of receiving at least one parameter of the downhole pumping system and is capable of controlling at least one operating parameter of the motor, and where the observer is capable of estimating at least one operating condition of the downhole pumping system. Other embodiments of this aspect include corresponding computer systems, apparatus, and computer programs recorded on one or more computer storage devices, each configured to perform the actions of the methods.

Implementations may also include one or more of the following features. The apparatus where the computing device is capable of monitoring the at least one parameter over a predetermined time interval and comparing the at least one parameter to a predetermined set of limits of the at least one parameter. The apparatus where the computing device is capable of determining a condition of the downhole pumping system where the condition is a stable condition if the at least one parameter is within the predetermined set of limits and where the condition is an abnormal condition is determined if the at least one parameter is outside of the predetermined set of limits. The apparatus where the computing device is capable of correlating the at least one parameter over the predetermined time interval to produce a correlated data set. Implementations of the described techniques may include hardware, a method or process, or computer software on a computer-accessible medium.

Another general aspect includes a method for monitoring the condition of an electromechanical system including: measuring at least one parameter of the electromechanical system, monitoring the at least one parameter, comparing the at least one parameter to a predetermined set of limits of the at least one parameter, and determining a condition of the electromechanical system. Other embodiments of this aspect include corresponding computer systems, apparatus, and computer programs recorded on one or more computer storage devices, each configured to perform the actions of the methods.

Implementations may also include one or more of the following features. The method further including correlating the at least one parameter over a predetermined time interval to produce a correlated data set. The method determining a stable condition if the at least one parameter is within the predetermined set of limits and determining an abnormal condition if the at least one parameter is outside of the predetermined set of limits. Implementations of the described techniques may include hardware, a method or process, or computer software on a computer-accessible medium.

### BRIEF DESCRIPTION OF THE DRAWINGS

So that the manner in which the above-recited features of the present disclosure can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic representation of a downhole pumping system.

FIG. 2 is a graphical representation of shaft speed and rotational angle versus time in accordance with an embodiment of the present disclosure.

FIG. 3 is a graphical representation of shaft speed and rotational angle versus time in accordance with an embodiment of the present disclosure.

FIG. 4 is a polar graphical representation of shaft speed versus shaft rotational angle with respect to time in accordance with an embodiment of the present disclosure.

FIG. 5 is a polar graphical representation of shaft speed versus shaft rotational angle with respect to time in accordance with an embodiment of the present disclosure.

FIG. 6 is a polar graphical representation of shaft speed versus shaft rotational angle with respect to time in accordance with an embodiment of the present disclosure.

FIG. 7 is flow chart of a process in accordance with an embodiment of the present disclosure.

FIG. 8 is schematic representation of a regulating unit for use in certain embodiments of the present disclosure.

FIG. 9 is a graphical representation of shaft speed and motor current versus time in accordance with an embodiment of the present disclosure.

FIG. 10 is flow chart of a process in accordance with an embodiment of the present disclosure.

FIG. 11 is a graphical representation of shaft speed versus time in accordance with an embodiment of the present disclosure.

FIG. 12 is a graphical representation of motor current versus time in accordance with an embodiment of the present disclosure.

### DETAILED DESCRIPTION

In the following detailed description of the embodiments, reference is made to the accompanying drawings, which form a part hereof, and within which are shown by way of illustration specific embodiments by which the examples described herein may be practiced. It is to be understood that other embodiments may be utilized and structural changes may be made without departing from the scope of the disclosure.

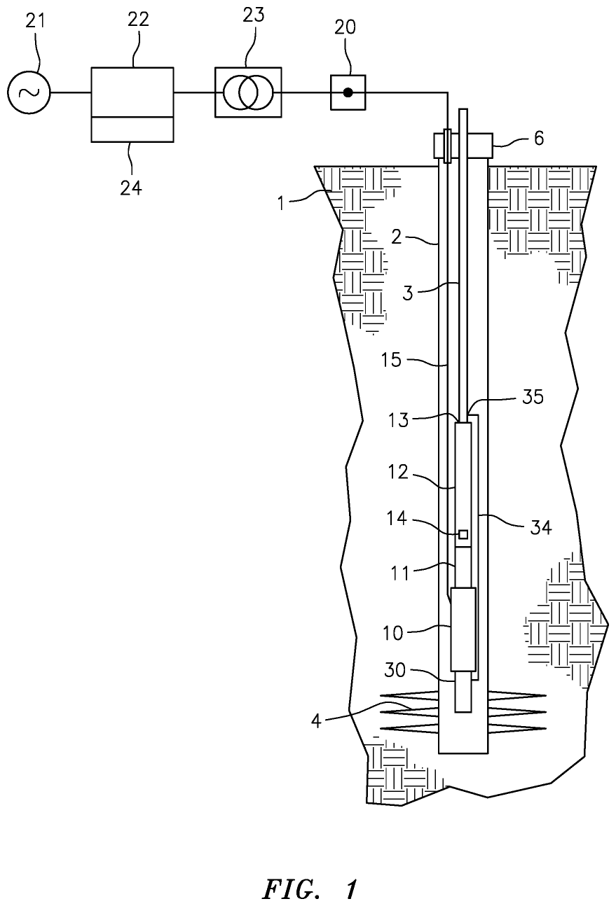

Embodiments of the present description address many of the issues raised hereinbefore using a systematic electrical method and apparatus. The component parts and methods can variously be used in sequence or independently while remaining within the scope of the invention. The present disclosure is a monitoring and control system comprising a variable speed drive that could include vector drive control of any type of rotating machinery system to determine, in real time, the instantaneous angular position, speed and torque of the shaft of the motor. An embodiment of the vector control of the present disclosure includes an observer wherein a model of the operation of the motor is used to infer the instantaneous angular position, speed and torque of the shaft of the motor by monitoring physical parameters such as supplied voltages and currents. An exemplary embodiment of the present disclosure includes a vector controlled PMM driven pumping system such as shown in FIG. 1. Such a vector control system includes variants of second order generalized integrator (SOGI) controllers as set forth in co-pending PCT patent serial number PCT/US18/19924, the disclosure of which is included herein in its entirety. In alternative embodiments, an observer can be produced as a stand-alone piece of equipment with voltage and current sensors connected between the motor and drive or can be embodied as a software add-in, and used with existing drives and switchboards. These embodiments would, for example, include scalar control of induction motors and a form of vector control known in the art as direct torque control that does not use an angle observer.

An embodiment of a vector control drive 22 representative of the present disclosure comprises an observer and current controller. An outer speed regulator loop adjusts the current controller set point up or down to adjust the actual speed of the motor to a predetermined set speed. Using, for example only, a PMM electrical circuit motor model, the measured surface voltage is corrected, using the measured current, for the resistive and inductive voltage drop in the motor winding, connecting cable and step-up transformer. The resulting voltage is characteristic of the motor rotating electromotive force (emf) including amplitude and angle. A phase-locked loop, of which many types are known in the art, which can comprise the aforementioned SOGI, is then used to measure the electrical frequency and angle of the emf. The in-phase and quadrature components of the current relative to the emf can then be determined and regulated by adjusting the drive output voltage. In the present disclosure, only the output of the observer is required, and observers may be derived for any motor type using the appropriate motor model. Because drive 22 performs its computations at a very high rate, on the order of up to 8 kHz or more, throughout each rotation of the shaft of motor 10, sufficient data is available. It is this very high sampling rate that enables embodiments of the present disclosure to sensorlessly track the rotor angle of motor 10 as a useful metric in controlling and monitoring the operation of a rotating system as will be more fully described herein below. Drive 22 can include a computing device and non-volatile memory capable of processing the sampled data. Although described herein as a part of drive 22, an embodiment of the present disclosure includes a device separate from drive 22 with its own voltage and current measurement sensors (or access to the corresponding sensors within drive 22) could embody an observer as herein described to achieve the same result. For instance, a central processor in which algorithms of the aforementioned observer are executed to compute rotor angle, in combination with other electrical data such as current. The algorithms are executed several thousand times a second and the output can be stored in a fast memory buffer. This permits embodiments of the present disclosure to receive the data, read out, store and post process the data at a lower urgency. For instance, bursts of data, or processed results, can be transmitted to other systems (such as SCADA systems) at a lower representative communication rate. Because there is typically a big data rate problem in transmission from remote locations, such embodiments of the present disclosure process the data locally in drive 22 and transmit lower rate metrics, such as frequency of current or torque disturbances, to for example, monitor debris or gas as will be more fully described herein below. It should be appreciated by those skilled in the art that a typical SCADA system, and in practice most remotely located submersible pump systems, are only able to transfer data very slowly, if at all. The methods of the present disclosure utilize the aforementioned local high-speed recording and some data reduction. Of particular importance, high-speed sampled data synchronous to shaft rotation angle is acquired by the control algorithm in drive 22.

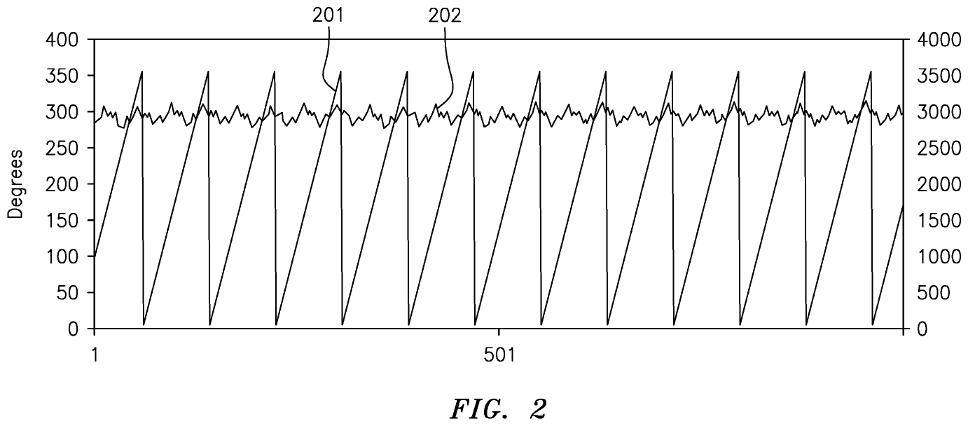

Referring now to FIG. 1 generally, and FIG. 2 more specifically, there is shown a graphical representation of a monitoring and control system in accordance with an embodiment of the present disclosure. In this particular embodiment, a motor, such as PMM 10, is controlled by drive 22 using vector control to establish stator currents at a predetermined level to maintain a nominal operating speed of the shaft of the motor. The observed electrical shaft angle of PMM 10 with respect to time is shown as line 201. As can be seen, line 201 shows that PMM 10 is operating in a nearly constant rate of change of angle between 0 degrees and a full rotation of 360 degrees (on the left-hand scale) on a repeating basis. Similarly, the mechanical observed rotational shaft speed of PMM 10 with respect to time, in revolutions per minute (rpm) (on the right-hand scale), is shown as line 202. It should be appreciated by those skilled in the art that for say a 4-pole motor 10 there are two electrical rotations per physical mechanical rotation of the shaft. The system observes a minimum corresponding number of electrical angle change multiples for each mechanical change in angle. In this example the multiple is two. As can be seen, line 202 shows that PMM 10 is operating at an approximately constant speed of about 3000 rpm, where speed is the time derivative of the shaft angle. As described herein above, PMM 10 is under vector control wherein the stator currents are maintained to produce the nearly constant shaft speed 202. With a steady load, the current will be steady. It should be appreciated that the time scale of FIG. 2 shows approximately 12 rotational cycles at an operating speed of 3000 rpm (right hand scale) and represents approximately 1000 data points at a sampling rate of 4000 hertz. At this fairly high sampling rate it is possible to receive many data points per revolution of the shaft. In the embodiment shown in this particular figure, the rotational electromechanical system is operating within the predetermined limits and no abnormal conditions are detected. It should be further appreciated that if the shaft rotational speed of FIG. 2 was portrayed as the radius in a polar plot versus rotor shaft angle the result would be a nearly perfect circle as will be described more fully herein after.

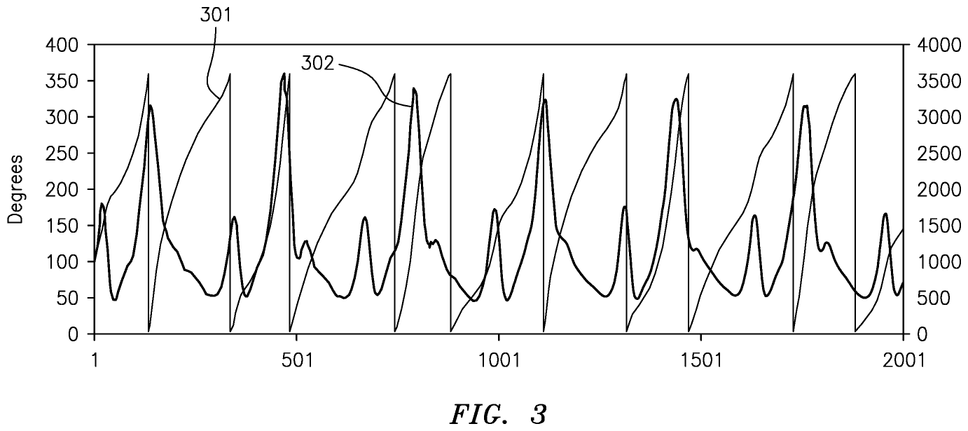

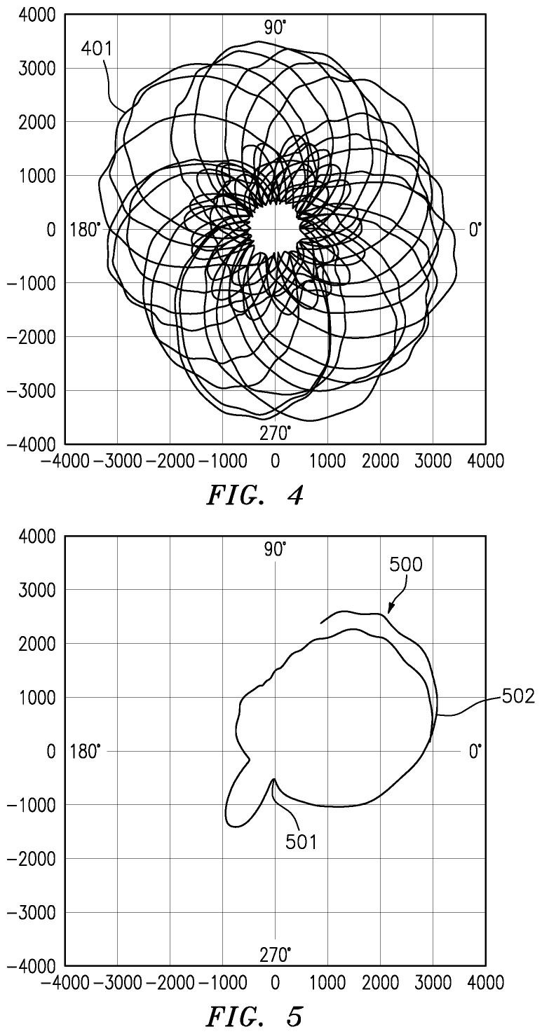

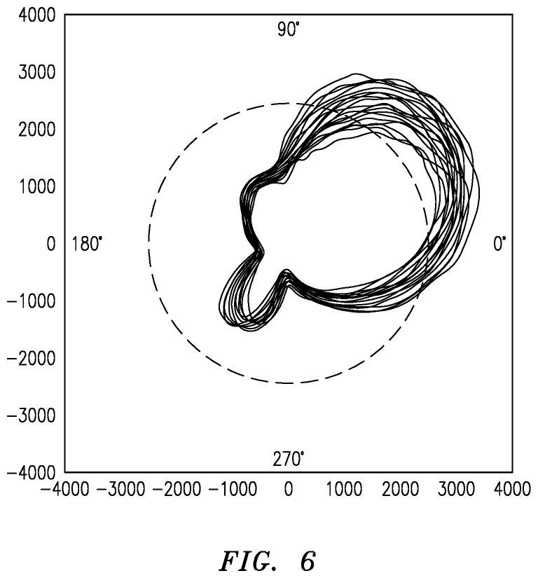

Referring now to FIG. 3 there is shown a graphical representation of a monitoring and control system similar to that described here in above with reference to FIG. 2 that similarly shows approximately 10 electrical rotational cycles at a nominal mechanical operating speed of 3000 rpm and represents approximately 1000 data points at a sampling rate of 4000 hertz. In this particular case, the present disclosure provides an indication of the existence of some operational abnormality. In this particular graphical representation, electrical rotational of PMM 10 with respect to time is shown as line 301. As can be seen, line 301 includes a nonlinear slope between angle 0 degrees and 360 degrees, and a non-constant rate of change of angular displacement thereby. Similarly, the instantaneous mechanical rotational shaft speed of PMM 10 with respect to time is shown as line 302, which as stated herein before is the rate of change of the mechanical shaft angle. As discussed herein above, there are twice as many peaks of electrical shaft angle 301 as there are for mechanical rotational speed 302 because there are two electrical rotations per mechanical rotations due the fact PMM 10 is a four-pole motor. It should be noted that drive 22 is operating a speed control regulator with an update rate of approximately every 100 ms. At each update, drive 22 adjusts the vector controller current set point to adjust the supply current to the stator windings of motor 10 so as to control the motor shaft at an average constant speed of 3000 rpm. In this particular example, the period of one constant rotation is 20 ms. The vector controller can operate more than 100 times during the rotation to hold the current steady at its predetermined set point. However, as can be seen, line 302 shows that PMM 10 is operating at instantaneous speeds that vary between approximately 500 rpm and 3600 rpm within single rotations, which is much faster than the speed controller update rate, and so these variations occur over an interval where the vector controller is holding the motor current sensibly constant. It will be appreciated by those skilled in the art that if the torque required to maintain a constant speed varies then, while controlling the current to be steady, the rotational speed of the motor shaft will vary. In the embodiment shown in this particular figure, the instantaneous speed of the rotational electromechanical system is operating substantially outside of the predetermined average level and some abnormal condition is detected. The present disclosure reveals such variation and is indicative of such an operational abnormality as will be more fully described herein after. Referring now to FIG. 4, the example embodiment depicted in FIG. 3 is shown as a polar plot of shaft speed versus mechanical shaft rotational angle parametrically with respect to time for the same 5 mechanical revolutions of the shaft of motor 10. It should be appreciated that there is a pattern of the various rotational plots in FIG. 4 that appears to correlate to rotor angle. Each large loop (higher rotational speed) and small loop (lower rotational speed) pair 401 correspond to a single rotation, and successive rotations show the loops slipping in angle relative to each other indicating a slipping condition. Such speed fluctuations that vary with angle, or slip rates, could be an indication that the rotating machinery, such as a pump (12 in FIG. 1) attached to the motor shaft, and depending on pump type, is rubbing against the stationary portion of the pump or that a part such as a bearing is slipping. Referring now to FIG. 5, there is shown a polar plot of the shaft speed versus mechanical shaft rotational angle with respect to time for approximately a single revolution 500 of the shaft of motor 10 depicted in FIG. 4. It can be seen that the rotational speed varies from a minimum of about 500 rpm at point 501 to a maximum of approximately 3000 rpm at point 502. As described in relation to the embodiment shown in FIG. 5, it is shown that the speed fluctuation correlates to the motor rotor angle. It is an aspect of the present disclosure that the correlation of a physical parameter of the rotating machinery with respect to motor shaft rotor angle is useful in detecting a pattern to identify a problem with the system. For example, if in the pumping system depicted in FIG. 1, the origin of the rotor angle of motor 10 is known relative to an absolute position of the rotor in the motor, and the orientation of the pump relative to the shaft is also known, then the present disclosure can be used to determine the mechanical orientation of a defect and could be further used to diagnose the defect in the pump-seal-motor assembly. As described herein above, the orientation of the speed fluctuation with respect to rotor angle can be determined. If this were a static condition, i.e. the minimum speed in a single rotation always occurred at point 501, that may indicate a certain type of mechanical issue with the rotating machinery, such as the lobe of a pump rubbing the stator in a single position on each rotation. However, and with reference back to FIG. 4, the polar plots 401 indicate a dynamic condition causing the speed fluctuations to change relative to rotor angle on successive revolutions. It is an aspect of the present disclosure that the investigation of the patterns associated with the rate of change of speed fluctuations relative to rotor angle on successive revolutions can yield valuable information concerning a mal-performing rotating machine that can help assist in the diagnosis of the cause of a dynamically changing condition. This aspect of the present disclosure can best be shown with reference to FIG. 6, where there is shown a polar plot of the rotational speed of the shaft of PMM 10 of the same 10 rotational cycles shown in FIG. 4 taken at sampling rate of 4000 hertz, but with the angle adjusted at a rate of approximately 0.205 degrees/sample, so demonstrating in this embodiment that a dynamic slipping/rub condition exists. It can be determined from the present disclosure that the rotating machinery system depicted in FIG. 6 has mechanical interference occurring in the quadrants representing angles between approximately 270 degrees and 180 degrees after slip correction.

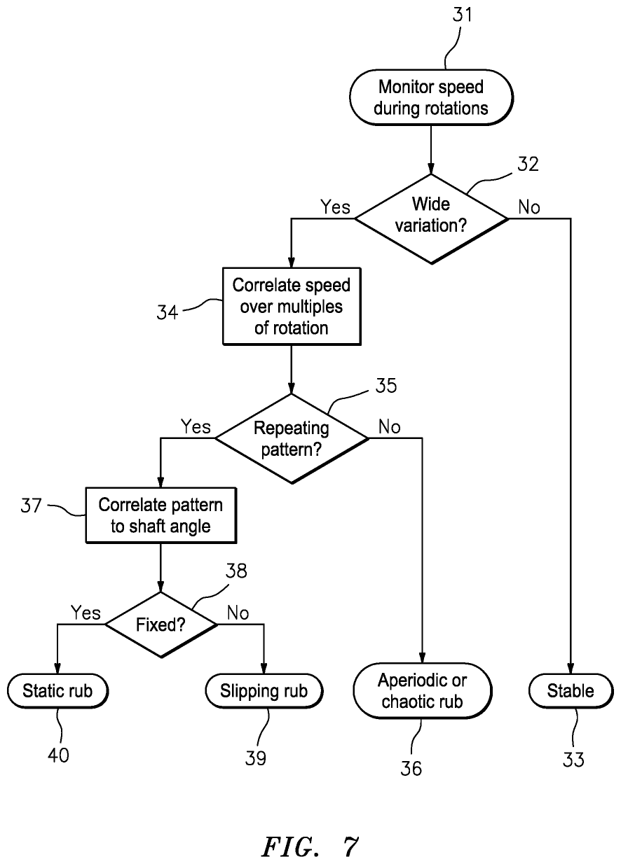

The monitoring, analysis and problem-solving methods enabled by the above described fast data capture of the system of the present disclosure described immediately herein above are best described with reference to FIG. 7. The drive 22 of the present disclosure is capable of capturing data related to the various operating parameters of the rotating equipment including shaft angle, voltages, currents as well as parameters related thereto at very high sampling rates in the thousands of hertz range. Such monitoring occurs in step 31 wherein data is captured and processed, by for example, the aforementioned central processor, at many points during a single rotation of motor 10. The data capture and processing during step 31 can be a continuous process or can be done at predetermined time intervals on real-time data or stored time windows of data. Such high speed real-time processing can usefully be achieved with programmable logic. The processed data can then be analyzed as in step 32 to determine whether the system is operating within acceptable predetermined limits of the parameters. If the analyzed data is within predetermined limits of the acceptable parameters, for example is within predetermined minimum and maximum limit values of speed, torque, voltage current, etc., then the method will report that the system is operating in a stable condition as indicated in step 33. If the analyzed data is not within the predetermined acceptable predetermined limits of the parameters the data can be further analyzed as in step 34 to attempt to correlate the frequency of the occurrence of variation over multiple rotations of the shaft of motor 10. Step 34 can be performed in batches offline and over various intervals of time. For instance, a 5-minute capture of data can be processed for an hour (or more) offline. The analyzed data is then examined to determine whether there is a pattern to the data that is related to other parameters of the system such as speed of the shaft in step 35. If no pattern is discernable in step 35 then the method can report that there is an aperiodic condition or a chaotic condition such as an aperiodic rub or a chaotic rub in step 36. If a pattern that repeats itself is identified in step 35 the data is further analyzed to determine whether the pattern is occurring at a frequency that is related to shaft angle in step 38. If the analyzed data from step 37 shows it is periodic, i.e. there is a periodic pattern to the data, but the pattern is not fixed relative to shaft angle, then the system can report that the problem can be a slipping condition of a rub as indicated by step 39. This type of anomalous operating behavior is similar to that described herein above relative to FIGS. 3-6. If the data analyzed in step 38 is discovered to have a repeating pattern that occurs at a periodic frequency that is fixed to the rotation of the shaft then the system reports a static rubbing condition as indicated by step 40. Each of the conditions reported at steps 36, 39 and 40 can be caused by an event that can be determined from a post event investigation and added to a library of preexisting periodic patterns as possible conditions. The library can be accessed as part of the method herein described to alert an operator of not only abnormal operation of the system but also a possible cause of the abnormal operating condition. The method of the present disclosure also includes taking action to control the operation of the system based on the abnormal conditions reported in steps 36, 39 and 40 such as slowing down the motor 10, speeding up the motor, controlling the surface tubing choke, notifying the operator, shutting down the system, comparing the condition to the library of conditions or other actions.

In other embodiments of the present disclosure it is also possible to determine operating abnormalities wherein the speed or the current of the motor 10 can fluctuate as a function of time on a longer timescale than in the example embodiments provided herein above. For instance, in a system having rotating machinery such as a pump 12 (FIG. 1) where a pattern in the speed fluctuation isn't resolvable, the operating abnormality may can be determined to be pumping fluid based. Such fluctuations do not vary consistently with respect to rotor angle as discussed herein above, can be indicative of time varying events, such as, for example, wax plugging, mechanical thrust overload, sand, slugs or gas passing through the pump. The short duration of such fluctuations means they are typically missed by well-known SCADA systems as the communication update rate of the SCADA system is too slow. The present disclosure contemplates monitoring the signals and deriving properties such as the rate of occurrence of the fluctuations or the pattern type of the instantaneous speed with respect to angle, so that simple parameters of condition can be transmitted at lower rates. For example, a parameter of fluctuations over one hour transmitted every few minutes could show an increasing trend indicating more sand and wear. A parameter associated with a rubbing pattern could be dealt with by the controller automatically reducing the motor speed to reduce the problem. Other embodiments of the present disclosure include predetermined sequence of speed changes to clear debris causing rubbing.

It should be appreciated by those skilled in the art that the monitoring and control system of the present disclosure not only provides the capability to control the motor and monitor the condition of a pumping system down hole, but also yields important information regarding the causes for operational abnormalities and suggesting corrective steps. The information regarding the causes of the abnormalities allows controlling of pumping systems of the present disclosure to avoid harmful conditions, such as rubbing in the pump, by varying the speed of the pump in an effort to determine operating conditions where the pump is no longer rubbing. Similarly, in conditions where sand production is determined by the present disclosure, the motor may be slowed to prevent sand from being produced at a rate that is harmful to the pump. For instance, and as described herein above, drive unit 22 typically operates on speed control mode. When gas slugs are detected by the present disclosure, drive unit 22 can be switched to control the current, and the torque of motor 10 thereby. In other words, when slugs are detected by the present disclosure, the current can be held steady whereby the speed of motor 10 will be allowed to fluctuate and compress the gas and restore the head of pump 12, thereby preventing the gas from locking up the pump. When the present disclosure detects that the slugging has ceased, motor 10 speeds up automatically and control 22 returns to speed control mode as described herein above. In this example, when gas enters pump 12 the current to motor 10 will decrease while on speed control mode and the drive will switch to current control mode. For instance, if initially on speed control mode and providing 30 amps, and slugs are encountered the present embodiment switches over to current control mode and varies the current around the 30 amp set point, the motor 10 and pump 12 speeds stay somewhat constant and allow the slugs to pass. Referring now FIG. 8, there is shown an embodiment of the present disclosure that includes a regulating unit 51 that can be incorporated into drive 22 to run PMM 10 on current control mode. Regulating unit 51 includes a speed controller 52 and an outer, or average current, controller 53. Controllers 52 and 53 may be of known proportional-integral type. Controllers 52 and 53 preferably incorporate limits 52′, 52″ and 53′, 53″ on their outputs. In this particular embodiment, outer controller 53 is placed in front of the speed controller 52 and feeds a dynamically computed set speed signal to the speed controller. In operation, the operator selects a desired set-average-current value as input to outer controller 53. Controller 53 computes a set-speed value and sends that signal to speed controller 52 via 58. In turn, the speed controller 52 computes a set-stiff(hard)-current which is accepted via line 57 by the vector current controller as a current value to be rapidly and accurately sent to the motor 10 via optional step up transformer 54. Outer controller 53 receives average current feedback via filter 56 from speed controller 52 in the form of the set-stiff-current value. In the case of an induction motor, controlled by a scalar drive, the voltage can be varied to hold the current approximately steady or left fixed to hold the speed approximately steady.

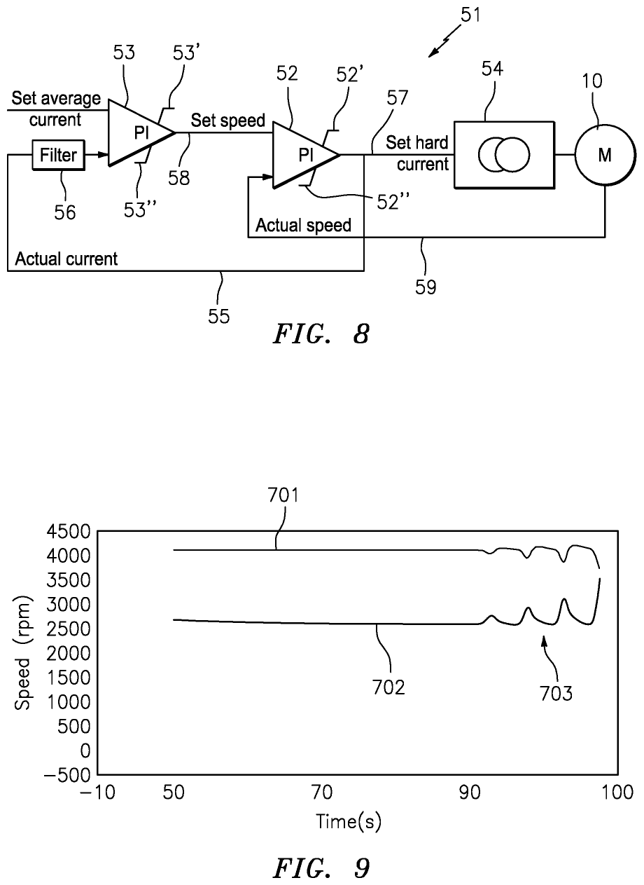

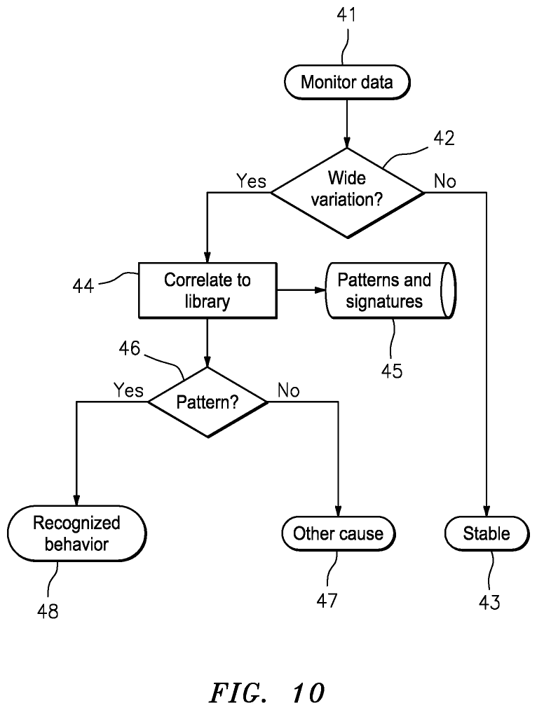

Now referring to FIG. 9, there is shown a graphical representation of an embodiment of the present disclosure wherein an abnormality is detected using a longer time scale than the embodiments described herein above. Line 701 represents the rotational speed of the shaft of a motor 10 (FIG. 1) in rpm and line 702 represents the current delivered to the motor by drive 22. As is shown, the motor is running at a suitably constant rate between 50 seconds and 90 seconds as indicated on the bottom scale. During the roughly 10 second time interval between 90 seconds and 100 seconds, indicated by region 703, an anomaly is observed wherein the speed 701 and current 702 vary. In some prior art systems, this variation may be large enough to have the drive unit shut down as an out of control default safety measure. In this embodiment of the present disclosure, using the motor models and sensed parameters, the system detects these anomalies and correlates the event with other periods of operation. For instance, the system of the present disclosure can cross-correlate, or auto-correlate as will be discussed in more detail below, the signals of region 703 with preceding 10 second intervals to determine a cause for the anomaly. It should be appreciated by those skilled in the art that such longer time scale observances of the present disclosure can even be useful at determining anomalies that occur over longer periods of time such as hours or even days and enabling the identification of root causes for the anomalies. However in the example of FIG. 9, it is necessary to sample on the order of 50 or 100 times per second to capture the necessary detail.

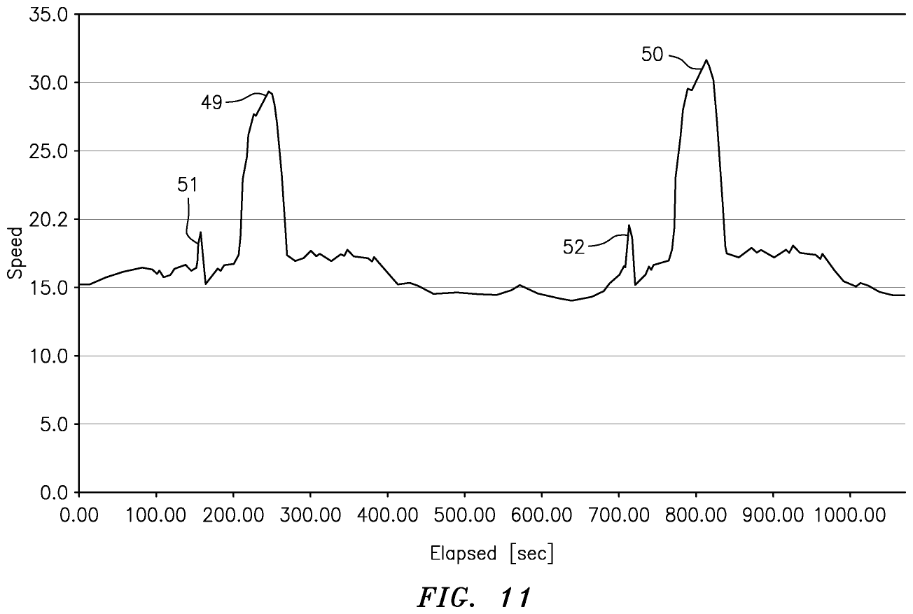

Additional monitoring, analysis and problem-solving methods enabled by the above described medium speed data capture (slower relative to the fast capture described above but faster than prior art SCADA systems) of the system of the present disclosure described immediately herein above are best described with reference to FIG. 10. As described herein above, drive 22 of the present disclosure is capable of capturing data related to the various operating parameters of the rotating equipment including shaft angle, voltages, currents, downhole and surface pressures, gas and liquid flow rates, as well as parameters related thereto at very high sampling rates in the thousands of hertz range. In certain circumstances it can be advantageous to review data at a slower rate, such as every 100 ms as described immediately herein above. Such monitoring occurs in step 41 wherein data is captured and processed at a rate slower than the than the rotation of motor 10. The data capture and processing during step 41 can be a continuous process or can be done at predetermined time intervals on real-time data or stored time windows of data. Such medium speed real-time processing can usefully be achieved with programmable logic. The processed data can then be analyzed as in step 42 to determine whether the system is operating within predetermined acceptable predetermined limits of the parameters. If the analyzed data is predetermined acceptable predetermined limits of the parameters, for example is within predetermined minimum and maximum limit values of speed, torque, voltage current, etc., then the method will report that the system is operating in a stable condition as indicated in step 43. If the analyzed data is not within the predetermined acceptable parameters the data can be further analyzed as in step 44 to attempt to correlate the frequency of the occurrence of variation over relatively longer periods of time to occurrences of the conditions of patterns and signatures stored in library 45. The library is similar to that described herein. Step 44 can be performed continuously or in batches offline and over various intervals of time. For instance, a 20-minute (or longer) capture of data can be processed for an hour (or more) offline. The analyzed data is then examined to determine whether there is a pattern to the data that is related to other parameters of the system such as speed or other recognized pattern or signature from the library in step 46. If no recognized pattern or signature in library 45 then the method can report that there is some unknown cause of the abnormal operating condition in step 47. If the data matches recognized pattern or signature in library 45 in step 46 then the system can report that the abnormal behavior is a known problem at step 48. The conditions reported at step 47, can be caused by an event that can be determined from a post event investigation and added to library 45. The method of the present disclosure also includes taking action to control the operation of the system based on the abnormal conditions reported in steps 36, 39 and 40 such as slowing down the motor 10, speeding up the motor, choking the well, notifying the operator, shutting down the system, further monitoring the system and comparing the condition to the library of conditions or other actions.

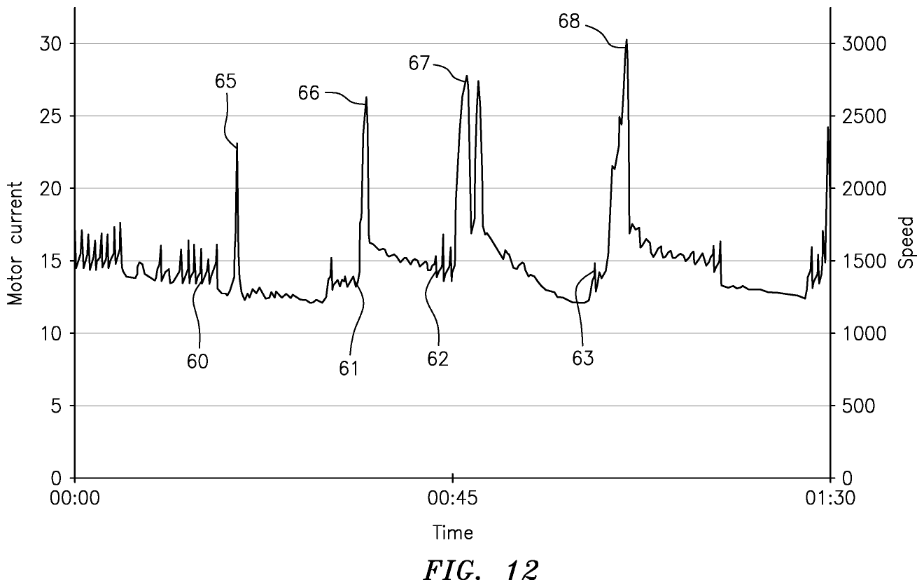

The advantage of the medium speed data rate capture can be visualized with reference to FIG. 11 where speed data is captured at a 100 ms rate over an approximate 18 minute time interval. The method described immediately herein above would recognize at step 42 that, at least with regard to spikes 49, 50. that the current of motor 10 is not within the predetermined acceptable parameters. The abnormal condition is a pattern of a short short spike 51, 52 followed by a long spike 49, 50 wherein the condition lasts approximately 50 seconds and repeats itself approximately every 9 minutes. The system would attempt to correlate the repeating pattern with information stored in library 45 and if there is a correlation the condition would be reported at step 48 and if there was no correlation the system can report that there is some unknown cause of the abnormal operating condition in step 47. The spikes themselves have signatures of high amplitude for a short time, and this signature, or activity in the current, is a simple output to alert the operator to unusual conditions.

Another embodiment of the medium speed data rate of the current disclosure capture can be visualized with reference to FIG. 12 where motor current data is captured at a rate of every 5 seconds over an approximate 1.5 hour time interval. The method described immediately herein above would recognize at step 42 that that the motor current is not within the predetermined acceptable parameters. The abnormal condition is a a series of high frequency spikes 60-63 are followed by higher spikes in current 64-67 wherein the higher spikes increase in amplitude and wherein the pattern repeats itself every 11-17 minutes or so. The system would attempt to correlate the repeating pattern with information stored in library 45 and if there is a correlation the condition would be reported at step 48 and if there was no correlation the system can report that there is some unknown cause of the abnormal operating condition in step 47. Such a pattern could indicate that the recognized behavior is that there was a blockage in the tubing (low current) leading to thrust load in the pump that caused friction (high current) occurring in the pump 12 and the recommended correction could be to clear the blockage by flushing the tubing.

It is an aspect of the present disclosure that a library of fault conditions can be assembled corresponding to the sensed signals. For instance, in the embodiment discussed relating to FIGS. 3-6, if it were discovered in a post event inspection that the rotating machine system comprised a pump and a rotating part was rubbing against the stationary portion of the pump, the signal pattern could be added to the library indicating this type of problem. The library could be populated over time and reside within non-volatile memory on drive 22, or on a non-volatile memory accessible device located elsewhere. An embodiment of the present disclosure can use the library to correlate signal patterns with known problems to not only identify problems but also change operating parameters in response to alerts of problems to avoid the particular problem as described herein above.

In the embodiments of the present disclosure, it is now possible to obtain data from the motor of a rotating machinery system without attached sensors in order to monitor normal conditions as well as to determine problems that can exist in the system. In certain embodiments, such problems can best be detected and analyzed by correlating the time series data as described herein above to produce a correlated data set, with respect to shaft rotation angle, if the phenomenon is rotation-cyclic. In some embodiments, the data can be cross-correlated, autocorrelated as well as analyzed using known artificial intelligence techniques trained on data at different time scales and time resolution, without requiring shaft rotation angle such as when it is due to loading conditions such as from debris or gas entering a pump. For example, in embodiments using autocorrelation, also known as serial correlation, the signals obtained by the system of the present disclosure as described herein above, are captured at different predetermined time intervals. A first signal time series is correlated with a second signal time series, which second signal time series is a delayed copy of first signal time series, as a function of the delay. Informally, this is the similarity, or dissimilarity, between observed signal series as a function of the time lag between them. Used in this manner, autocorrelation is an embodiment of the present disclosure that enables the finding of repeating patterns, such as those set forth herein above. It is useful in this particular embodiment for analyzing the signals in the time domain. Although autocorrelation is but one method of analyzing the signals of the present disclosure, it is useful in determining problems with the rotating machinery of a system in cases involving statistical anomalies related to unit root processes, trend stationary processes, autoregressive processes, and moving average processes. Wavelets may be used to investigate spiking data.

1-38. (canceled)

39. An apparatus for monitoring a condition of an electromechanical system comprising:
any of a current sensor electrically coupled to the electromechanical system and adapted to determine a current and a voltage sensor electrically coupled to the electromechanical system and adapted to determine a voltage;
a computing device electrically coupled to the electromechanical system comprising an observer adapted to receive any of the current and the voltage and adapted to determine any of an instantaneous angular position, an instantaneous rotational speed and an instantaneous torque of a shaft; and
the computing device adapted to use any of the instantaneous angular position, the instantaneous rotational speed and the instantaneous torque of the shaft to determine and a condition of the electromechanical system.

40. The apparatus of claim 39 wherein the computing device is configured to correlate the instantaneous angular position and the instantaneous rotational speed of the shaft over a short time interval to produce an angle correlated data set.

41. The apparatus of claim 40 wherein the computing device is configured to correlate any of the instantaneous angular position, the instantaneous rotational speed and the instantaneous torque of the shaft over with respect to time over a long time interval to produce a time correlated data set.

42. The apparatus of claim 41 wherein the computing device is configured to determine whether the condition is a stable condition or an abnormal condition.

43. The apparatus of claim 41 further comprising the computing device configured to determine whether a particular periodic pattern exists within any of the angle correlated data set and the time correlated data set.

44. The apparatus of claim 43 further comprising:
a library comprised of a plurality of possible conditions of the electromechanical system and a plurality of periodic patterns;
wherein at least one of the plurality of possible conditions is associated with at least one of the plurality of periodic patterns;
wherein the computing device is configured to compare the particular periodic pattern in the angle correlated data set to the plurality of periodic patterns; and
the computing device is configured to report one of the plurality of possible conditions of the electromechanical system if the particular periodic pattern in any of the angle correlated data set and the time correlated data set matches any one of the plurality of periodic patterns and to report a different one of the plurality of possible conditions of the electromechanical system if no correlated data set exists.

45. The apparatus of claim 44 wherein the particular periodic pattern in the angle correlated data set correlates to the instantaneous angular position and the computing device is configured to report that the condition is a synchronous condition and wherein the computing device is configured to report that the condition is an asynchronous condition when the particular periodic pattern in the correlated data correlates to the instantaneous angular position upon an application of a slip correction factor.

46. The apparatus of claim 43 wherein no particular periodic pattern is determined in any of the angle correlated data set and the time correlated data set and the computing device is configured to report one of an aperiodic condition, a chaotic condition or an unknown abnormal condition.

47. The apparatus of claim 41 wherein the electromechanical system comprises:
a motor;
a pump coupled to the motor; and
a drive configured to control the motor.

48. The apparatus of claim 47 wherein the drive is configured to change at least one of the current, the voltage, the instantaneous angular position, the instantaneous rotational speed and the instantaneous torque of the electromechanical system.

49. The apparatus of claim 48 wherein the observer is configured to receive data related to the electromechanical system at a rate of 10 hertz to 8000 hertz.

50. An apparatus for monitoring a downhole pumping system comprising:
a motor having a shaft;
a pump coupled to the shaft of the motor;
a drive electrically capable of being coupled to a power source and to the motor, the drive comprising a computing device, an observer and a non-volatile memory;
wherein the drive is adapted to control any of a current and a voltage to the motor;
wherein the observer is adapted to determine any of an instantaneous angular position, an instantaneous rotational speed and an instantaneous torque of a shaft using any of the current and the voltage; and
wherein the computing device is adapted to determine a condition of the downhole pumping system.

51. The apparatus of claim 50 wherein the computing device is adapted to monitor any of the instantaneous angular position, the instantaneous rotational speed and the instantaneous torque over a predetermined time interval and to compare any of the instantaneous angular position and the instantaneous rotational speed to a predetermined set of limits.

52. The apparatus of claim 51 wherein the condition is a stable condition if the instantaneous angular position, the instantaneous rotational speed and the instantaneous torque is within the predetermined set of limits and wherein the condition is an abnormal condition if any of the instantaneous angular position and the instantaneous rotational speed is outside of the predetermined set of limits.

53. The apparatus of claim 52 wherein the computing device is adapted to correlate the instantaneous angular position to the instantaneous rotational speed over a short time interval to produce an angle correlated data set.

54. The apparatus of claim 53 wherein the computing device is configured to correlate any of the instantaneous angular position, the instantaneous rotational speed and the instantaneous torque of the shaft over with respect to time over a long time interval to produce a time correlated data set.

55. The apparatus of claim 54 further comprising the computing device is further adapted to determine whether a particular periodic pattern exists within any of the angle correlated data set and the time correlated data set.

56. The apparatus of claim 55 further comprising:
a library stored in the non-volatile memory comprised of a plurality of possible conditions of the downhole pumping system and a plurality of periodic patterns;
wherein at least one of the plurality of possible conditions is associated with at least one of the plurality of periodic patterns;
wherein the computing device is configured to compare the particular periodic pattern in the angle correlated data set to the plurality of periodic patterns; and
the computing device is configured to report one of the plurality of possible conditions of the downhole pumping system if the particular periodic pattern in any of the angle correlated data set and the time correlated data set matches any one of the plurality of periodic patterns.

57. The apparatus of claim 56 wherein the particular periodic pattern in the angle correlated data correlates to the instantaneous angular position and the computing device is adapted to report that the condition is a synchronous condition and wherein the particular periodic pattern in the angle correlated data does not correlate to the instantaneous angular position and the computing device is adapted to report that the condition is an asynchronous condition.

58. The apparatus of claim 57 wherein no periodic pattern is determined in any of the angle correlated data set and the time correlated data set and the computing device is adapted to report one of an aperiodic condition a chaotic condition or an unknown abnormal condition.

59. The apparatus of claim 52 wherein the drive is adapted to change an operating parameter of the motor in response to an abnormal condition.

60. The apparatus of claim 59 further comprising the drive adapted to control the motor in either a speed control mode or a current control mode.

61. The apparatus of claim 60 wherein the observer is adapted to receive any of the current and the voltage of the downhole pumping system at a rate of 10 hertz to 8000 hertz.

62. A method for monitoring a condition of an electromechanical system comprising:
measuring any of a current and a voltage of the electromechanical system;
determining an instantaneous angular position, an instantaneous rotational speed and an instantaneous torque of a shaft using any of the current and voltage;
monitoring any of the instantaneous angular position, the instantaneous rotational speed and the instantaneous torque; and
determining a condition of the electromechanical system.

63. The method of claim 62 further comprising correlating the instantaneous angular position and the instantaneous rotational speed over a short time interval to produce an angle correlated data set and correlating any of the instantaneous angular position, the instantaneous rotational speed and the instantaneous torque of the shaft over with respect to time over a long time interval to produce a time correlated data set.

64. The method of claim 63 further comprising determining a stable condition if the instantaneous angular position, the instantaneous rotational speed and the instantaneous torque are within a predetermined set of limits and determining an abnormal condition if any of the instantaneous angular position, the instantaneous rotational speed and the instantaneous torque are outside of the predetermined set of limits.

65. The method of claim 64 further comprising determining whether a particular periodic pattern exists within any of the angle correlated data set and the time correlated data set.

66. The method of claim 65 further comprising:
providing a library comprised of a plurality of possible conditions of the electromechanical system and a plurality of periodic patterns, wherein at least one of the plurality of possible conditions is associated with at least one of the plurality of periodic patterns;
comparing the particular periodic pattern in any of the angle correlated data set and the time correlated data set to the plurality of periodic patterns; and
reporting one of the plurality of possible conditions of the electromechanical system if the particular periodic pattern in any of the angle correlated data set and the time correlated data set closely resembles any one of the plurality of periodic patterns.

67. The method of claim 66 further comprising reporting that the condition is a synchronous condition when the particular periodic pattern in the angle correlated data set correlates to the instantaneous angular position and reporting an asynchronous condition when the particular periodic pattern in the angle correlated data set does not correlate to the instantaneous angular position upon an application of a slip correction factor.

68. The method of claim 65 further comprising reporting one of an aperiodic condition, a chaotic condition or an unknown abnormal condition when no periodic pattern exists in any of the angle correlated data set and the time correlated data set.

69. The method of claim 62 further wherein the determining of the instantaneous angular position, the instantaneous rotational speed and the instantaneous torque is performed by an observer.

70. The method of claim 69 wherein the electromechanical system includes a motor, the method further comprising controlling the motor with a vector drive.

71. The method of claim 70 further comprising changing any of the current and the voltage when an abnormal condition is determined.

72. The method of claim 71 receiving any of the current and the voltage by the observer at a rate of 10 hertz to 8000 hertz.
